(19) United States
(12) Patent Application Publication
(10) Pub. No.: US 2012/0207071 A1
(43) Pub. Date: Aug. 16, 2012

(54) ENHANCED POWER SAVE MULTI-POLL (PSMP) PROTOCOL FOR MULTI-USER MIMO BASED WIRELESS LOCAL AREA NETWORKS

(75) Inventors: Chunhui Zhu, San Jose, CA (US); Osama Aboul-Magd, Kanata (CA); Youngsoo Kim, Seoul (KR)

(73) Assignee: SAMSUNG ELECTRONICS CO., LTD., Suwon (KR)

(21) Appl. No.: 13/397,628

(22) Filed: Feb. 15, 2012

Related U.S. Application Data
(60) Provisional application No. 61/443,681, filed on Feb. 16, 2011.

(51) Int. Cl. H04W 52/02; G08C 17/02

(52) U.S. Cl. 370/311

(57) ABSTRACT

Wireless communication in a wireless communication system, comprises maintaining data blocks at a wireless transmitting station for transmission to multiple wireless receiving stations over a shared wireless communication medium, and simultaneously transmitting data blocks from the transmitting station over multiple spatial streams to multiple destination wireless receiving stations in a power save multi-poll (PSMP) sequence, via the wireless communication medium.

### CROSS-REFERENCE TO RELATED APPLICATIONS

This application claims priority from U.S. Provisional Patent Application

Ser. No. 61/443,681, filed Feb. 16, 2011, incorporated herein by reference.

### FIELD OF THE INVENTION

The present invention relates generally to wireless communications, and in particular to wireless communications using multiple antennas to wirelessly transmit multiple downlink traffic streams to multiple receiving stations.

### DESCRIPTION OF RELATED ART

In a typical wireless network utilizing a coordination function for coordinating transmissions among wireless stations, such a coordination function may be implemented in one of the wireless stations such as a wireless access point (AP) functioning as a coordinator. The wireless stations may communicate via directional transmissions using sector antennas and beam-forming antenna arrays. The coordinator may use omnidirectional transmissions for broadcasts to all wireless stations in all directions (e.g., 360 degrees range).

Alternatively, the coordinator may use quasi-omnidirectional transmissions for broadcasts to a wide range, but not necessarily in all directions. In many wireless area networks (WLANs) such as those according to IEEE 802.11 standards, a coordinator is used in infrastructure mode for providing contention-free access to a wireless communication medium to support Quality of Service (QoS) for certain applications.

### BRIEF SUMMARY OF THE INVENTION

Embodiments of the present invention provide multi-user (MU) multiple-input-multiple-output (MIMO) communication in a Power Save Multi-Poll (PSMP) sequence for a wireless communication system such as wireless network to support multiple downlink traffic streams to multiple receiver wireless stations simultaneously.

Wireless communication in a wireless communication system, comprises maintaining data blocks at a wireless transmitting station for transmission to multiple wireless receiving stations over a shared wireless communication medium, and simultaneously transmitting data blocks from the transmitting station over multiple spatial streams to multiple destination wireless receiving stations in a power save multi-poll (PSMP) sequence, via the wireless communication medium.

These and other features, aspects and advantages of the present invention will become understood with reference to the following description, appended claims and accompanying figures.

### BRIEF DESCRIPTION OF THE DRAWINGS

FIG. 1 shows an illustration of the conventional PSMP scheduling and transmission sequence in the current IEEE 802.11 standard.

FIG. 2 shows frame formats of a PSMP frame, which is one of the High Throughput (HT) Action frames.

FIG. 3A shows a block diagram of a wireless system implementing multi-user (MU) multiple-input-multiple-output (MIMO) communication in PSMP sequence, according to an embodiment of the present invention.

FIGS. 3B-3C shows DL MU-MIMO transmission in PSMP sequence, according to embodiments of the invention.

FIG. 4 shows an example STA_Info Field for Individually Addressed stations, according to an embodiment of the invention.

FIG. 5 illustrates PSMP Mixed Mode Operation, according to an embodiment of the invention.

FIG. 6 illustrates PSMP Mixed Mode Operation with Group Addressed DTT present, according to an embodiment of the invention.

FIG. 7 illustrates PSMP 802.11ac Green Field Mode PSMP sequence, according to an embodiment of the invention.

FIG. 8 illustrates a STA_INFO field (with STA_INFO Type=3) of the PSMP frame to reduce control overhead, according to an embodiment of the invention.

FIGS. 9A-9C illustrates a comparison of different STA_INFO fields.

FIG. 10 illustrates PSMP sequence for an alternative embodiment of IEEE 802.11ac Green Field Mode, according to the present invention.

FIG. 11 is a high level block diagram showing an information processing system for implementing an embodiment of the present invention.

### DETAILED DESCRIPTION OF THE INVENTION

The present invention relates to wireless communications using multiple antennas to wirelessly transmit multiple downlink traffic streams from a transmitting station to multiple receiving stations.

Generally in the absence of a coordinator, contention-free access to a shared wireless communication (e.g., a radio frequency (RF) channel) may be implemented using announcement or information exchange among wireless stations in a network to negotiate/reserve the use of the communication medium.

Embodiments of the present invention provide multi-user (MU) multiple-input-multiple-output (MIMO) communication in a Power Save Multi-Poll (PSMP) sequence for a wireless communication system such as wireless network to support multiple downlink traffic streams to multiple receiver wireless stations simultaneously.

In one embodiment, the present invention provides a communication system and protocol for wireless communication in a wireless local area network, wherein multiple antennas wirelessly transmit multiple downlink traffic streams (spatial streams) from a transmitting station to multiple receiving stations. In one embodiment, a communication protocol according to the present invention is useful with PSMP in the IEEE 802.11 wireless communication standard.

One implementation of said communication protocol according to the present invention provides an enhancement to said PSMP mechanism, wherein said communication protocol supports downlink (DL) multi-user (MU) multiple-input-multiple-output (MIMO) communication in one or more PSMP downlink transmission times (DTTs) in a PSMP sequence.

A frame structure is used for data transmission between wireless stations such as a transmitter station and a receiver station. In one example, a frame structure in a Media Access Control (MAC) layer and a physical (PHY) layer is utilized, wherein in a transmitter station, a MAC layer receives a MAC Service Data Unit (MSDU) and attaches a MAC header thereto, in order to construct a MAC Protocol Data Unit (MPDU). The MAC header includes information such as a source address (SA) and a destination address (DA). The MPDU is a part of a PHY Service Data Unit (PSDU) and is transferred to a PHY layer in the transmitter to attach a PHY header (i.e., PHY preamble) thereto to construct a PHY Protocol Data Unit (PPDU). The PHY header includes parameters for determining a transmission scheme including a coding/modulation scheme. The PHY layer includes transmission hardware for transmitting data bits over a wireless link. Before transmission as a frame from the transmitter station to the receiver station, a preamble is attached to the PPDU, wherein the preamble can include channel estimation and synchronization information.

### The Conventional PSMP Mechanism of the IEEE 802.11 Standard

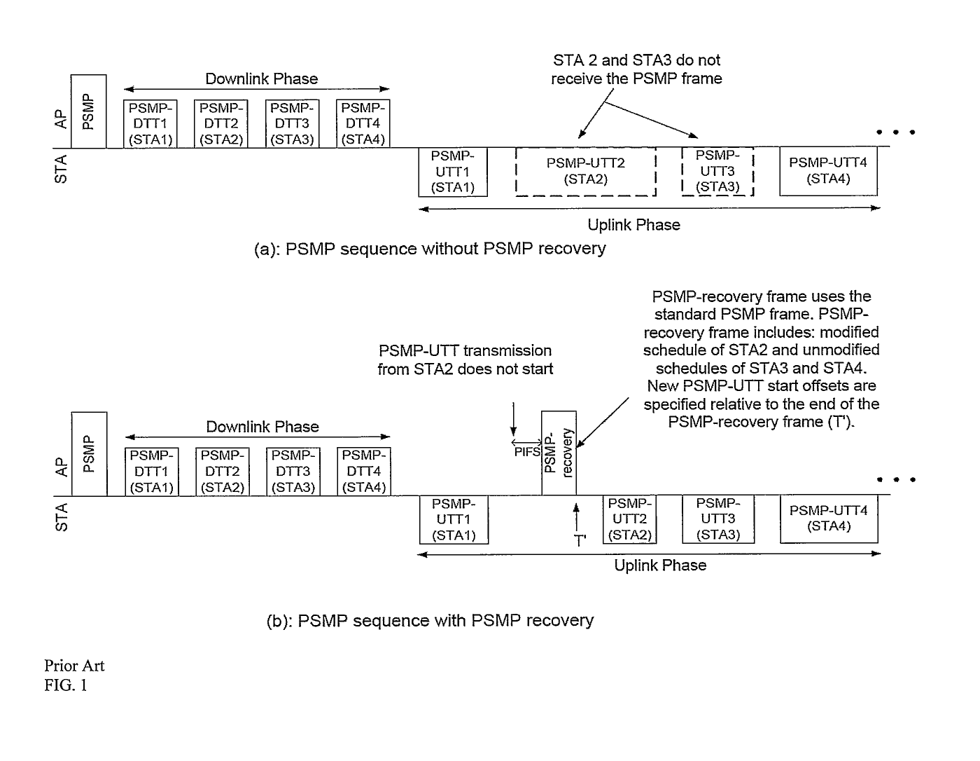

FIG. 1 shows an illustration of the conventional PSMP scheduling and transmission sequence in the current IEEE 802.11 standard. The PSMP mechanism provides a time schedule that is used by an access point (AP) and its associated STAs to access a wireless communication medium such as wireless radio frequency channel.

PSMP is used by an AP to schedule time periods to access the wireless communication medium for downlink transmission target STAs, as well as schedule time periods for target STAs to access the medium for uplink transmission to the AP. PSMP operation is under the control of a Hybrid Coordinator (HC), operating under a centralized access control scheme, and it is only available when traffic specifications (TSPECs) have been established between an AP and its target (associated) STAs. TSPECs are used by the AP to reserve resources within the AP and to modify the AP's scheduling behavior. The parameters in the TSPEC can be grouped into two categories for two purposes: PSMP scheduling and PSMP reservation.

The PSMP mechanism is controlled using a PSMP Action frame. PSMP Downlink Transmission Time (PSMP-DTT) is a period of time described by a PSMP frame during which the AP transmits. PSMP Uplink Transmission Time (PSMP-UTT) is a period of time described by a PSMP frame during which a non-AP station may transmit. A PSMP sequence is a sequence of frames where the first frame is a PSMP frame, followed by transmissions in zero or more PSMP-DTTs and then by transmissions in zero or more PSMP-UTTs. The schedule of the PSMP-DTTs and PSMP-UTTs is defined in the PSMP frame.

An AP transmits a PSMP frame containing a schedule only for target STAs that are awake. A target STA with an established PSMP session is awake at the start of the session's service period (SP) and remains awake until the end of the SP unless permitted to return to sleep as regulated in PSMP. A PSMP sequence may be used to transmit group addressed frames along with individually addressed frames. Individually addressed frames are scheduled after group addressed frames. During a PSMP sequence, a STA is able to receive frames during its scheduled PSMP-DTT and is not required to be able to receive frames at other times. A STA that has frames to send that are valid for transmission within the PSMP-UTT starts transmission without performing CCA and regardless of NAV at the start of its PSMP-UTT. STAs can save power by only waking up for receiving and transmitting at the pre-scheduled times and sleep for the rest of the times.

PSMP allows an AP station to schedule DTTs for a wireless station (STA) to wake up, receive downlink data frames, and go back to sleep. The AP further schedules UTTs for a STA to wake up, transmit to the AP, and go back to sleep. The scheduling is based on the traffic specification the STAs negotiated with the AP. By using PSMP, a STA is able to wake up for receiving and transmitting only at the scheduled times and to sleep for the rest of the time. This saves the power consumption of the STA. The PSMP mechanism allows an AP to transmit to one STA at a time within one DTT in a PSMP sequence.

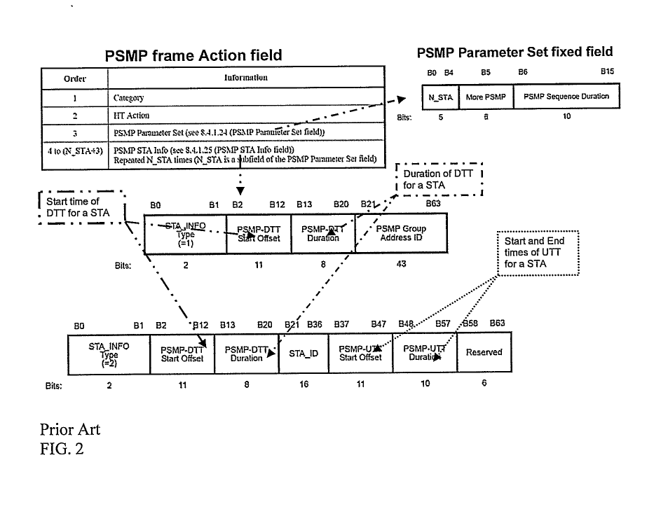

FIG. 2 shows frame formats of a PSMP frame, which is one of the High Throughput (HT) Action frames. In a PSMP frame, the AP indicates to the target STAs the following information: the number of downlink and uplink transmissions in this PSMP sequence and the number of STAs that are to be targeted, the total duration of the PSMP sequence, the time and duration a STA needs to wake up for receiving and the time and duration a STA can transmit the uplink frames. Conventionally, a PSMP action frame is always transmitted before any PSMP-DTT and PSMP-UTT, as illustrated in FIG. 1.

### MU-MIMO PSMP Mechanism

According to an embodiment of the invention, a MU-MIMO PSMP communication protocol enables multi-user downlink transmissions in a PSMP sequence.

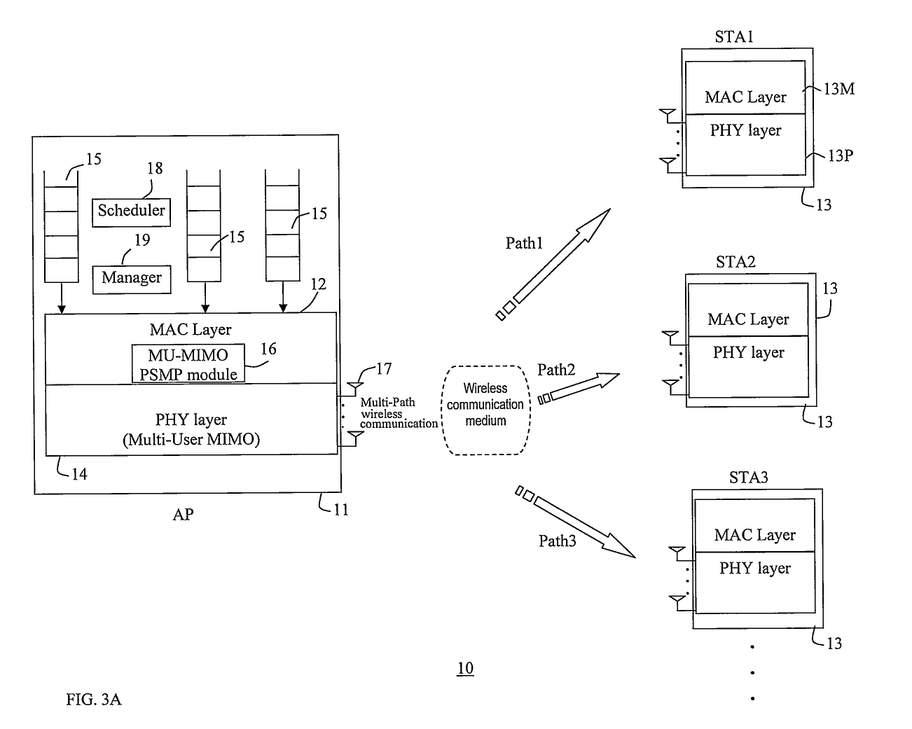

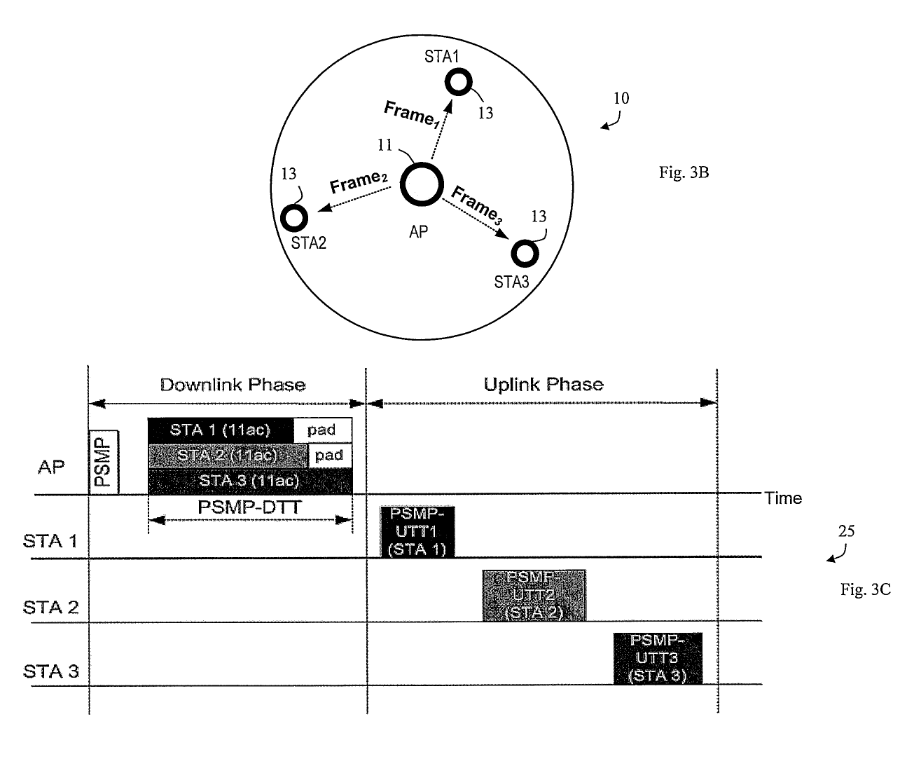

FIG. 3A shows a block diagram of a wireless system implementing multi-user MU-MIMO communication in PSMP sequence, according to an embodiment of the present invention. In one embodiment, said DL MU-MIMO transmission in PSMP sequence is implemented using a Mixed Mode and a Greenfield Mode to save station energy consumption in wakeup/sleep cycles.

Specifically, FIG. 3A shows a wireless network 10, according to an embodiment of the invention. The wireless network comprises a wireless local area network (WLAN) comprising multiple wireless stations. A STA-AP wireless station 11 comprises an access point (AP) having a PHY layer 14 and a MAC layer 12 including a channel access module 16 which implements DL MU-MIMO transmission in PSMP sequence, according to an embodiment of the invention. Several traffic streams (or queues) of data frames (packets) at the AP station 11 are for transmission to multiple receiver wireless stations 13. Each wireless station 13 comprises a MAC layer 13M and a PHY layer 13P.

In this example, there are three traffic streams (or queues) of data frames (packets) at the AP station 11 for transmission to receiver wireless stations 13 (i.e., STA-1, STA-2 and STA-3), respectively. In one embodiment, the system operates in hybrid coordination function controlled channel access (HCCA). For each STA that has uplink traffic to send to the AP, channel time is scheduled accordingly. Embodiments of the invention are useful with wireless devices where power saving is important, such as mobile wireless devices operating on battery power. A STA communicates with the AP and provides its traffic specification (TSPEC) to the AP for channel access scheduling.

FIGS. 3B-3C show DL MU-MIMO transmission in PSMP sequence according to embodiments of the invention, wherein multiple traffic streams are transmitted to different receivers simultaneously via multiple spatial streams. FIG. 3B shows a diagram of a wireless system implementing MU-MIMO communication in PSMP sequence, according to an embodiment of the present invention. FIG. 3C shows a timing diagram of wireless channel access and transmission sequence in MU-MIMO communication in PSMP sequence, according to an embodiment of the present invention.

Specifically, FIG. 3B illustrates an example downlink transmission in a wireless network 10 involving MU-MIMO transmission of frames 1, 2, 3 from the AP station 11 (AP) to the receiver stations 13 (STA1, STA2, STA3) during MU-MIMO communication, respectively, via directional transmissions over the wireless communication medium, according to an embodiment of the invention.

Further, FIG. 3C shows a timing diagram 25 for the example communication in FIG. 3B, wherein during a MU-MIMO PSMP communication sequence, in a downlink phase, the AP station 11 simultaneously directionally transmits three frames 1, 2, 3 (each with a specified destination receiver station address (RA)) to the receiver stations 13 (STA1, STA2 and STA3), respectively. In an uplink phase, each of the receiver stations 13 may send a block acknowledgement (BA) and its uplink data frames to the AP station 11 sequentially using a predefined schedule, over the wireless communication medium.

Said MU-MIMO PSMP communication according to an embodiment of the invention allows one PSMP-DTT to be shared by a physical layer convergence procedure (PLOP) protocol data unit (PPDU) targeting at different receiving STAs by using multiple sets of spatial streams enabled by DL MU-MIMO. Further, MPDUs sent by an AP STA within a DTT in a MU-MIMO PSMP sequence may contain MPDUs of multiple TIDs. As such, in one embodiment the MU-MIMO PSMP mechanism provides flexibility of transmission scheduling and efficiency.

In one embodiment, the MU-MIMO PSMP mechanism provides DL MU-MIMO support for wireless devices implementing wireless communication based on IEEE 802.11ac standard. In one implementation of the MU-MIMO PSMP mechanism according an embodiment of the invention, PSMP Mixed Mode allows PSMP-DTTs and PSMP-UTTs for both IEEE 802.11n and IEEE 802.11ac devices, to be scheduled in the same PSMP sequence. As such, a MU-MIMO DTT and a conventional DTT can be transmitted in one single PSMP sequence (by using different STA_Info type). The word “Mixed” herein means mixing different type of STA_Info fields in the PSMP frame. Further, a PSMP Green Field Mode reduces control overhead and provides a way of DL MU-MIMO transmission under HCF Controlled Channel Access (HOCA) for IEEE 802.11ac. There is no need for a Group ID, providing less power consumption.

As such, according to embodiment of the invention, MU-MIMO PSMP is a PSMP sequence where at least one DTT is transmitted using the MU-MIMO technology. MU-MIMO DTT is a DTT during which the PPDUs are transmitted using the MU-MIMO technology. PSMP 11ac Green Field Mode is a PSMP operation mode which allows only MU-MIMO DTT(s) to be transmitted in a PSMP sequence. PSMP Mixed Mode is a PSMP operation mode which allows both legacy DTT (under IEEE 802.11n operation rules) and MU-MIMO DTT to be transmitted in the same PSMP sequence.

### PSMP Mixed Mode

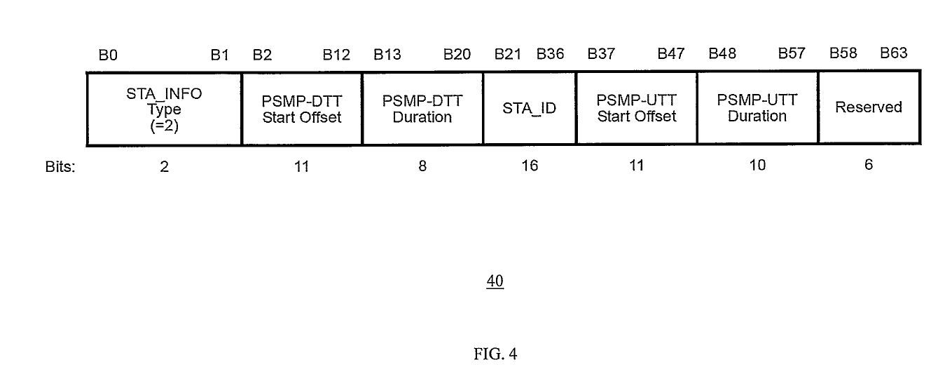

FIG. 4 shows an example STA_Info Field 40 for Individually Addressed STAs, according to an embodiment of the invention. When the PSMP Mixed Mode is used for unicast DTTs, both IEEE 802.11n and IEEE 802.11ac devices use the STA_Info Field 40 formatted to indicate individual addresses (STA_ID). The STA_INFO Type value must equal to 2 for both IEEE 802.11n and IEEE 802.11ac devices, as illustrated in FIG. 4.

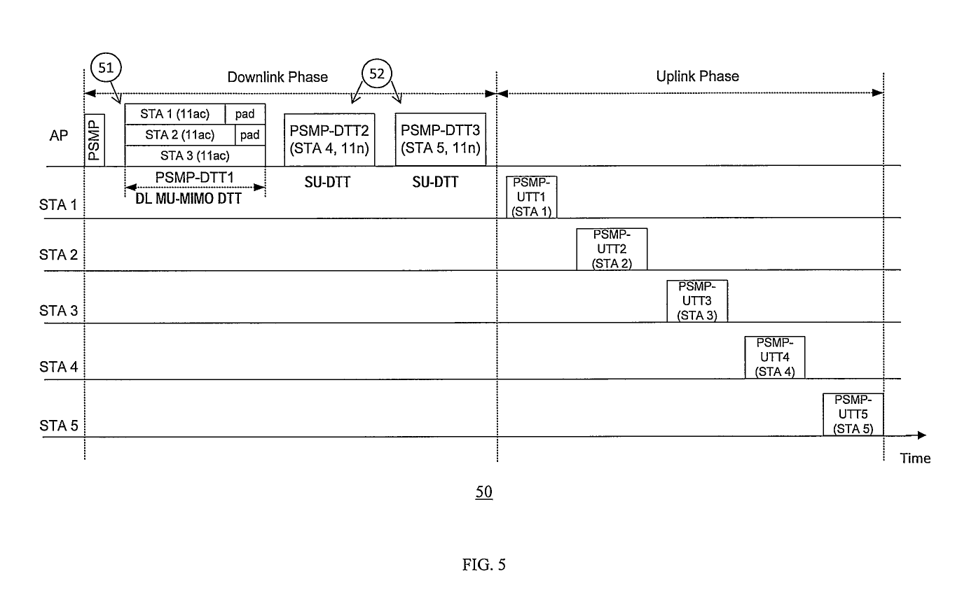

As shown by example in FIG. 5, illustrating a PSMP Mixed Mode process 50 without a Group Addressed DTT present, according to an embodiment of the invention. In process block 51, when there is no Group Addressed DTTs in the downlink phase, a DL MU-MIMO DTT (e.g., PSMP-DTT1) is scheduled at the beginning of the downlink phase. Thereafter, in process block 52, conventional DTTs for Single-User (SU-DTT) transmissions (e.g., PSMP-DTT2 and PSMP-DDT3), are scheduled.

For example in FIG. 5, STA1-STA3 need not go back to sleep before the start time of each arrives. Further, if STA4 receives a start time that is not current, it has to go to sleep and wakeup when DTT1 finished transmission, and it wakes up again and starts transmission and then goes back to sleep. If DTT2 or DTT3 are placed before DTT1, then STA1-STA3 all go back to sleep and then wait until DTT2 and DTT3 finish transmission and all three STA1-STA3 have to wake up again, which consumes power.

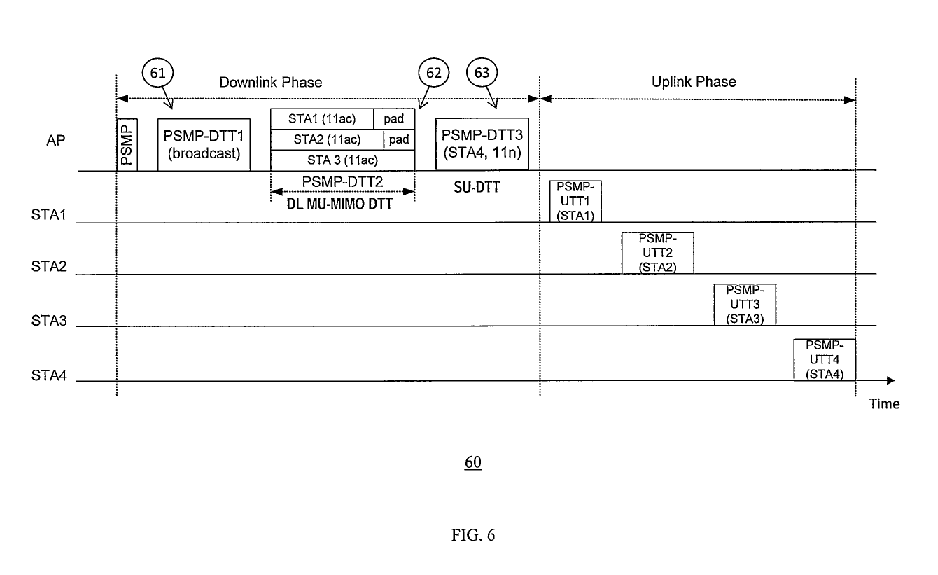

FIG. 6 illustrates PSMP Mixed Mode process 60 with Group Addressed DTT present (e.g., PSMP-DTT1), according to an embodiment of the invention. In this case, in process block 61 group addressed DTTs (e.g., PSMP-DTT1) are scheduled at the beginning of the PSMP sequence. Then in process block 62, the DL MU-MIMO DTTs (e.g., PSMP-DTT2) are scheduled for transmission, wherein the next DTTs to be transmitted are DL MU-MIMO DTTs. Then in process block 63, SU-DTTs (e.g., PSMP-DTT3) are scheduled for transmission.

For the uplink scheduling, the UTTs for STAs included in a MU-MIMO DTT can be determined by the AP flexibly. For example, in FIG. 5 and FIG. 6, STA3 may transmit in UTT1 and STA1 may transmit in UTT3. The AP can determine which STA obtains uplink transmission first based on the TSPEC and the current status and request of each STA.

To allow simultaneous transmissions of MU-MIMO PPDUs to multiple IEEE 802.11ac capable STAs, the AP can schedule the same PSMP-DTT Start Offset and PSMP-DTT Duration for the MU-MIMO DTT in a PSMP frame. All targeted STAs need to wake up for the length of this MU-MIMO DTT. Each STA has its own PSMP-UTT Start Offset and PSMP-UTT Duration scheduled in the PSMP frame. In case different STAs have different PPDU lengths, they can be scheduled into different PSMP-DTTs such that PPDUs of similar length can be grouped together to allow STAs to stay wake up only when necessary.

Extremely short or long PPDUs should be transmitted without using MU-MIMO, if power consumption is the major concern. This is because STAs receiving short frames will be forced to stay awake longer than what it needs when using MU-MIMO DTT and STAs receiving long frames will force other STAs to stay awake longer than what they need, when using MU-MIMO DTT. The balance between throughput and power consumption is considered.

### PSMP Green Field Mode

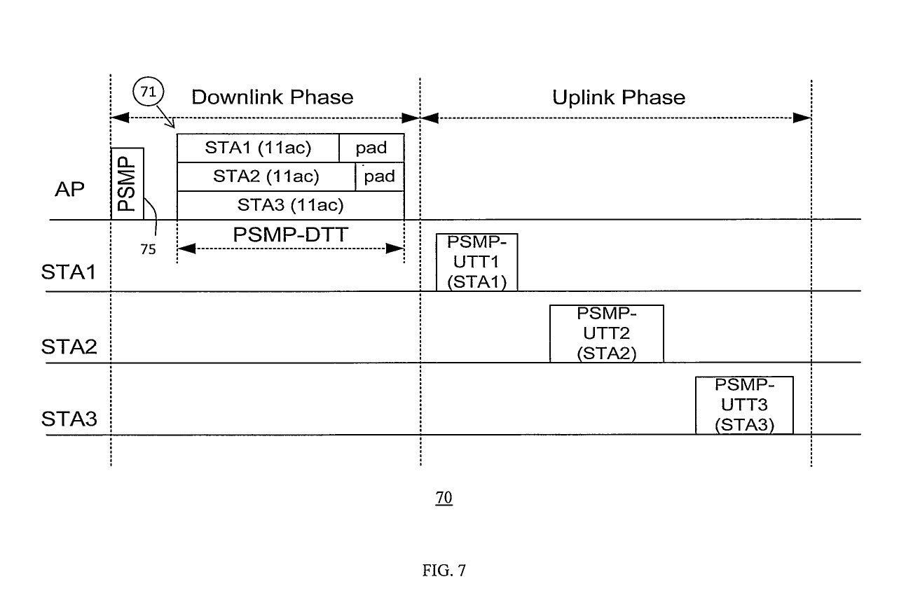

FIG. 7 illustrates PSMP 802.11ac Green Field Mode process 70, according to an embodiment of the invention. According to process block 71, after a PSMP frame 75, a PSMP sequence contains only one DL MU-MIMO DTT to achieve higher efficiency. There is only one DTT in the PSMP sequence, however, multiple MSDU/A-MSDU can be aggregated into a PHY layer PPDU and transmitted within a PSMP-DTT. In the DTT of a Green Field PSMP sequence, the STAs can only be individually addressed STAs. As such, there are no group addressed DTTs, nor single-user DTTs, in the Green Field mode. Therefore, for group addressed DTTs and/or single-user DTTs appearing with the MU-MIMO DTT, the PSMP is running in a Mixed Mode.

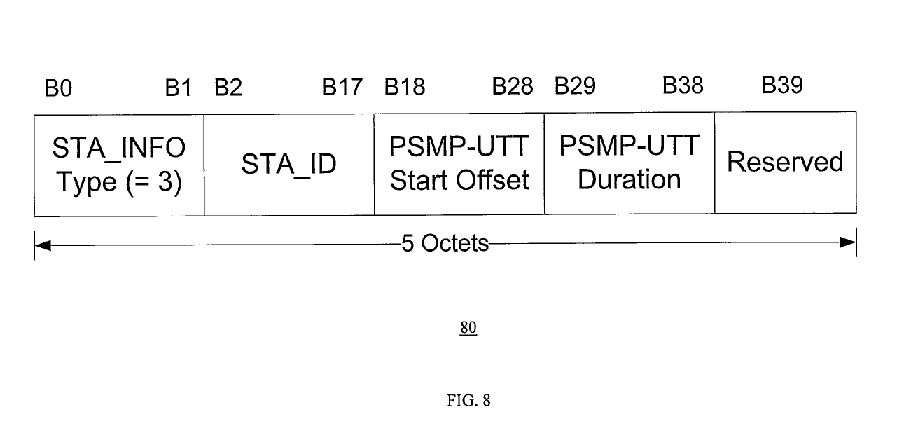

According to an embodiment of the invention, a new STA_INFO field 80 for the PSMP frame is provided to reduce control overhead, as illustrated in FIG. 8. The STA_INFO field 80 includes individual receiving station addresses (STA JD). In the STA_INFO field 80, a STA_INFO Type is set to 3 (one of the reserved values in IEEE 802.11n standard), to indicate a MU-MIMO PSMP transmission. There is no PSMP-DTT Start Offset field because this DTT is always transmitted immediately after the PSMP frame when no Group Addressed DTTs present. There is no PSMP-DTT Duration (as in the IEEE 802.11n individual address format) because STAs can detect the end of the transmissions and they know when to transmit their own data frames by reading the PSMP-UTT Start Offset field. In one embodiment, during one MU-MIMO DTT, there can be at most 4 target STAs for transmission. When there are more than 4 targeted STAs, the following two approaches can be used:
1. Use the PSMP Burst mechanism (transmit additional PSMP frames, which is overhead).
2. Use an approach according to an alternative embodiment of the present invention, described below. If this approach is used, the AP includes both PSMP-DTT Start Offset and PSMP-DTT Duration in the STA_INFO field, which is also an overhead.

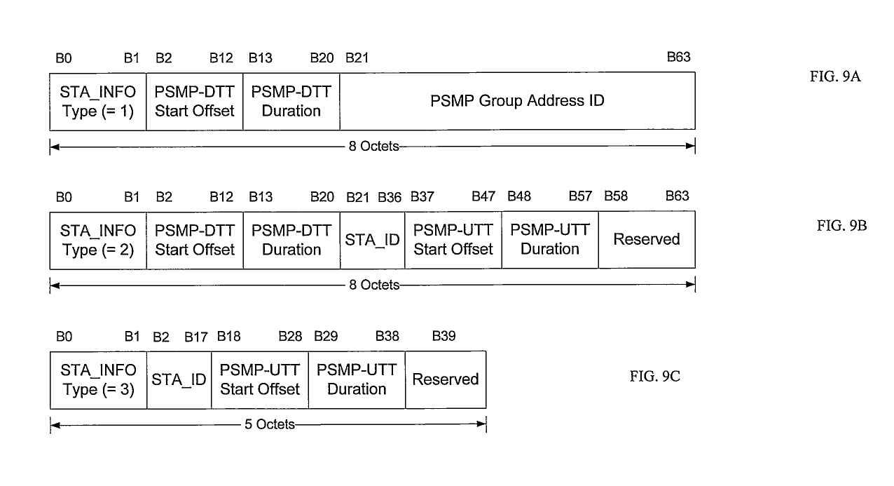

FIGS. 9A-9C illustrates a comparison of different STA_INFO fields. The STA_INFO fields in FIGS. 9A-9B are conventional. The new STA_INFO format in FIG. 9C for the IEEE 802.11ac green field mode, according to an embodiment of the invention, is about 37.5% (⅜) shorter than other STA_INFO types (FIGS. 9A and 9B), whereby the control overhead is reduced. It has only 5 bytes, with the PSMP-DTT start, PSMP-DTT offset and PSMP-DTT duration, removed. This is because the downlink MIMO is transmitted immediately after the PSMP frame, whereby there is no need to assign a start time for the stations.

### An Alternative Embodiment of PSMP IEEE 802.11ac Green Field Mode

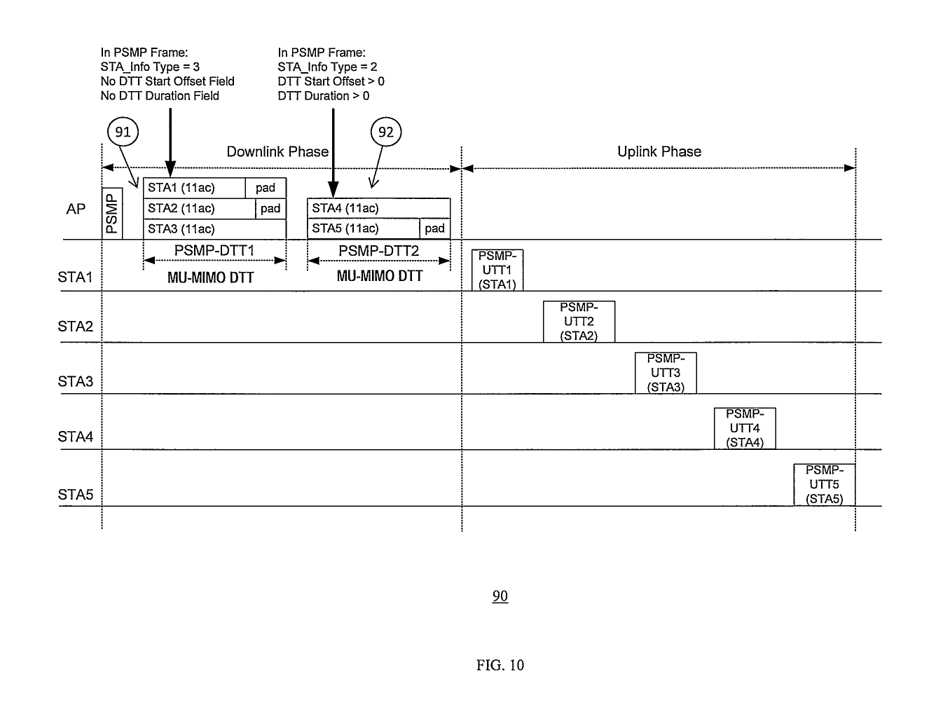

FIG. 10 illustrates PSMP sequence process 90 for an alternative embodiment of IEEE 802.11ac Green Field Mode, according to the present invention. Specifically, when there is a need to transmit to more than four STAs (e.g., at least five stations STA1-STA5), the PSMP IEEE 802.11ac Green Field Mode can be extended according to an embodiment of the invention, wherein in process block 91 for STAs to be included in a first MU-MIMO DTT (e.g., PSMP-DTT1), their STA_INFO Type is set to 3 (without DTT start offset and DTT duration fields) and schedules for transmission. Further, in process block 92, for STAs to be included in a second MU-MIMO DTT (e.g., PSMP-DTT2) and beyond, their STA_INFO Type is set to 2 and scheduled for transmission, such that the AP can set appropriate values for their DTT start offset and DTT duration fields. This provides efficiency in between the IEEE 802.11ac Green Field Mode and the PSMP Mixed Mode. This is more efficient using a PSMP burst approach for multiple PSMP IEEE 802.11ac Green Field sequences, which requires a PSMP frame to be placed in front of each PSMP sequence.

Using DL MU-MIMO according to embodiments of the invention, multiple frames can be transmitted to different STAs in one DTT simultaneously, increasing network throughput. Further, multiple SIFSs can be saved between different DTTs, which saves network bandwidth. Using said DL MU-MIMO, the sleeping cycle can be reduced, which reduces transmission delay for delay sensitive applications.

Conventionally in one DTT, the transmitted frames must have the same RA. Each STA can be targeted only once by the AP in one PSMP sequence. When there are multiple DTTs, although STAs can save power during the sleeping period, transmission delay is also long since the AP takes turns to transmit to different STAs. Conventionally, individually addressed entries in the PSMP frame have their PSMP-DTT and PSMP-UTT start offsets scheduled to minimize the number of on/off transitions or to maximize the delay between their PSMP-DTT and PSMP-UTT periods.

According to embodiments of the invention, a STA need not go to sleep before its own DTT, and may transmit immediately after receiving a PSMP frame. This reduces number of On/Off (Wakeup/Sleep) transitions (power saving). Further, neither PSMP-DTT Start Time nor PSMP-DTT Duration are needed since each entry starts at the same time (SIFS after PSMP frame), and the end of the transmission can be detected by every receiver so it can go back to sleep until their UTT arrives. This simplifies scheduling of the start offsets of each addressed entry. Because PSMP operation relies on TSPEC, an AP can perform better scheduling for DL MU-MIMO transmission, based on the TSPEC parameters. An example involves determining which STAs should be grouped together into one PPDU for downlink transmission. In addition, backward compatibility is provided such that mixed IEEE 802.11n and IEEE 802.11ac transmissions can share the same PSMP sequence.

As is known to those skilled in the art, the aforementioned example architectures described above, according to the present invention, can be implemented in many ways, such as program instructions for execution by a processor, as software modules, microcode, as computer program product on computer readable media, as logic circuits, as application specific integrated circuits, as firmware, as consumer electronic devices, etc., in wireless devices, in wireless transmitters/receivers, in wireless networks, etc. Further, embodiments of the invention can take the form of an entirely hardware embodiment, an entirely software embodiment or an embodiment containing both hardware and software elements.

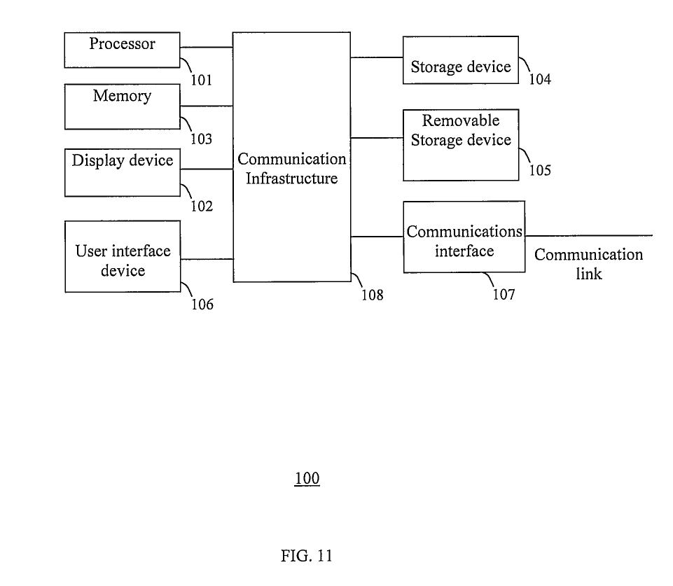

FIG. 11 is a high level block diagram showing an information processing system comprising a computer system 100 useful for implementing an embodiment of the present invention. The computer system 100 includes one or more processors 101, and can further include an electronic display device 102 (for displaying graphics, text, and other data), a main memory 103 (e.g., random access memory (RAM)), storage device 104 (e.g., hard disk drive), removable storage device 105 (e.g., removable storage drive, removable memory module, a magnetic tape drive, optical disk drive, computer readable medium having stored therein computer software and/or data), user interface device 106 (e.g., keyboard, touch screen, keypad, pointing device), and a communication interface 107 (e.g., modem, a network interface (such as an Ethernet card), a communications port, or a PCMCIA slot and card). The communication interface 107 allows software and data to be transferred between the computer system and external devices. The system 100 further includes a communications infrastructure 108 (e.g., a communications bus, cross-over bar, or network) to which the aforementioned devices/modules 101 through 107 are connected.

Information transferred via communications interface 107 may be in the form of signals such as electronic, electromagnetic, optical, or other signals capable of being received by communications interface 107, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments of the present invention have been described with reference to flowchart illustrations and/or block diagrams of methods, apparatus (systems) and computer program products according to embodiments of the invention. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing embodiments of the present invention. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer readable medium may comprise computer readable information in a transitory state medium such as a network link and/or a network interface, including a wired network or a wireless network, that allow a computer to read such computer readable information. Computer programs (i.e., computer control logic) are stored in main memory and/or secondary memory. Computer programs may also be received via a communications interface. Such computer programs, when executed, enable the computer system to perform the features of the present invention as discussed herein. In particular, the computer programs, when executed, enable the processor multi-core processor to perform the features of the computer system. Such computer programs represent controllers of the computer system.

Though the present invention has been described with reference to certain versions thereof; however, other versions are possible. Therefore, the spirit and scope of the appended claims should not be limited to the description of the preferred versions contained herein.

What is claimed is:

1. A method of wireless communication in a wireless communication system, comprising:
maintaining data blocks at a wireless transmitting station for transmission to multiple wireless receiving stations over a shared wireless communication medium; and
simultaneously transmitting data blocks from the transmitting station over multiple spatial streams to multiple destination wireless receiving stations in a POWER SAVE MULTI-POLL (PSMP) sequence, via the wireless communication medium.

2. The method of claim 1, wherein:
transmitting data blocks from the transmitting station comprises downlink (DL) multi-user (MU) multiple-input-multiple-output (MIMO) communication in one or more PSMP downlink transmission times (DTTs) in a PSMP sequence.

3. The method of claim 2, wherein said MU-MIMO PSMP communication includes sharing a PSMP-DTT by a physical layer convergence procedure (PLOP) protocol data unit (PPDU) targeting at different receiving stations by using multiple sets of spatial streams via DL MU-MIMO.

4. The method of claim 3, wherein:
each data block comprises a packet including an address of a destination receiving wireless station;
the method further comprising each destination receiving wireless station performing uplink (UL) transmission to the transmitting station in one or more PSMP uplink transmission times (UTTs) in a PSMP sequence; and
the transmitting station comprises a wireless access point (AP) which schedules DTTs and UTTs based on traffic specifications (TSPECs) established between the AP and the receiving stations.

5. The method of claim 4, further comprising:
providing a STA_INFO field in the PSMP frame, wherein the STA_INFO field includes individual receiving station addresses, and the STA_INFO Type is set to indicate a MU-MIMO PSMP transmission;
in a PSMP Mixed Mode, scheduling MU-MIMO DTTs and single user DTTs in the same PSMP sequence, using different STA_INFO fields in the PSMP frame;
wherein MU-MIMO DTT comprises a DTT during which the PPDUs are transmitted using the MU-MIMO.

6. The method of claim 5, wherein:
the transmitting station schedules the same PSMP-DTT Start Offset and PSMP-DTT Duration for a MU-MIMO DTT in a PSMP frame; and
each receiving station has its own PSMP-UTT Start Offset and PSMP-UTT Duration scheduled in a PSMP frame.

7. The method of claim 4, further comprising:
in a PSMP Green Mode, scheduling a MU-MIMO DTT to be transmitted in a PSMP sequence.

8. The method of claim 7, further comprising:
providing a STA_INFO field in the PSMP frame, wherein in the STA_INFO field, a STA_INFO Type is set to 3 to indicate a MU-MIMO PSMP transmission, and wherein a frame is always transmitted immediately after the PSMP frame, when no Group Addressed DTTs present.

9. The method of claim 7, further comprising:
allocating a group addressed DTT immediately after a PSMP frame, followed by MU-MIMO DTTs, followed by single-user DTTs, when no Group Addressed DTTs are present.

10. The method of claim 8, wherein there are two to four receiving wireless stations.

11. The method of claim 8, wherein there are at least five receiving wireless stations, such that:
for a receiving station to be included in a first MU-MIMO DTT, the STA_INFO Type is to 3, without DTT start offset and DTT duration fields; and
for a receiving station to be included in a second MU-MIMO DTT and beyond, the STA_INFO Type is set to 2, such that the transmitting station can set appropriate values for their DTT start offset and DTT duration fields.

12. The method of claim 4, wherein:
a receiving station need not go to sleep before its own DTT, and may transmit immediately after receiving a PSMP frame, thereby reducing number of On/Off (Wakeup/Sleep) transitions, and neither PSMP-DTT Start Time nor PSMP-DTT Duration are used; and
the wireless communication system comprises a wireless local area network.

13. A wireless station for wireless communication in a wireless communication system, comprising:
a communication physical layer configured for wireless communication over a shared wireless communication medium; and
a channel access module configured for maintaining data blocks for transmission to multiple wireless receiving stations over a shared wireless communication medium, and simultaneously transmitting data blocks over multiple spatial streams to multiple destination wireless receiving stations in a POWER SAVE MULTI-POLL (PSMP) sequence, via the wireless communication medium.

14. The wireless station of claim 13, wherein:
the wireless station comprises a multiple-input-multiple-output (MIMO) wireless station;
the channel access module transmits data blocks in downlink (DL) multi-user (MU) MIMO communication in one or more PSMP downlink transmission times (DTTs) in a PSMP sequence.

15. The wireless station of claim 14, wherein said MU-MIMO PSMP communication includes sharing a PSMP-DTT by a physical layer convergence procedure (PLOP) protocol data unit (PPDU) targeting at different receiving stations by using multiple sets of spatial streams via DL MU-MIMO.

16. The wireless station of claim 15, wherein:
each data block comprises a packet including an address of a destination receiving wireless station;
the wireless station comprises a wireless access point (AP) which schedules DTTs and UTTs based on traffic specifications (TSPECs) established between the AP and the receiving stations; and
each destination receiving wireless station performs uplink (UL) transmission to the AP in one PSMP uplink transmission time (UTT) in a PSMP sequence.

17. The wireless station of claim 16, wherein:
the channel access module utilizes a STA_INFO field in the PSMP frame, wherein the STA_INFO field includes individual receiving station addresses, and the STA_INFO Type is set to indicate a MU-MIMO PSMP transmission;
in a PSMP Mixed Mode, the channel access module schedules MU-MIMO DTTs and single user DTTs in the same PSMP sequence, using different STA_INFO fields in the PSMP frame;
wherein MU-MIMO DTT comprises a DTT during which the PPDUs are transmitted using the MU-MIMO.

18. The wireless station of claim 17, wherein:
the channel access module schedules the same PSMP-DTT Start Offset and PSMP-DTT Duration for a MU-MIMO DTT in a PSMP frame; and
each receiving station has its own PSMP-UTT Start Offset and PSMP-UTT Duration scheduled in a PSMP frame.

19. The wireless station of claim 16, wherein:
in a PSMP Green Mode, the channel access module schedules a MU-MIMO DTT to be transmitted in a PSMP sequence;

20. The wireless station of claim 19, wherein:
the PSMP frame includes a STA_INFO field, wherein in the STA_INFO field, a STA_INFO Type is set to 3 to indicate a MU-MIMO PSMP transmission, and wherein a frame is always transmitted immediately after the PSMP frame, when no Group Addressed DTTs present.

21. The wireless station of claim 19, wherein:
the channel access module allocates a group addressed DTT immediately after a PSMP frame, followed by MU-MIMO DTTs, followed by single-user DTTs, when no Group Addressed DTTs are present.

22. The wireless station of claim 20, wherein there are two to four receiving wireless stations.

23. The wireless station of claim 20, wherein there are at least five receiving wireless stations, such that:
for a receiving station to be included in a first MU-MIMO DTT, the STA_INFO Type is to 3, without DTT start offset and DTT duration fields; and
for a receiving station to be included in a second MU-MIMO DTT and beyond, the STA_INFO Type is set to 2, such that the transmitting station can set appropriate values for their DTT start offset and DTT duration fields.

24. The wireless station of claim 16, wherein:
a receiving station need not go to sleep before its own DTT, and may transmit immediately after receiving a PSMP frame, thereby reducing number of On/Off (Wakeup/Sleep) transitions, and neither PSMP-DTT Start Time nor PSMP-DTT Duration are used; and
the wireless communication system comprises a wireless local area network.

25. A wireless communication system, comprising:
a wireless station; and
a plurality of wireless receivers;
the wireless station comprising:
a communication physical layer configured for wireless communication over a shared wireless communication medium; and
a channel access module configured for maintaining data blocks for transmission to multiple wireless receiving stations over a shared wireless communication medium, and simultaneously transmitting data blocks over multiple spatial streams to multiple destination wireless receivers in a POWER SAVE MULTI-POLL (PSMP) sequence, via the wireless communication medium.

26. The system of claim 25, wherein:
the wireless station comprises a multiple-input-multiple-output (MIMO) wireless station;
the channel access module transmits data blocks in downlink (DL) multi-user (MU) MIMO communication in one or more PSMP downlink transmission times (DTTs) in a PSMP sequence.

27. The system of claim 26, wherein said MU-MIMO PSMP communication includes sharing a PSMP-DTT by a physical layer convergence procedure (PLOP) protocol data unit (PPDU) targeting at different wireless receivers by using multiple sets of spatial streams via DL MU-MIMO.

28. The system of claim 27, wherein:
each data block comprises a packet including an address of a destination wireless receiver;
the wireless station comprises a wireless access point (AP) which schedules DTTs and UTTs based on traffic specifications (TSPECs) established between the AP and the wireless receivers; and
each destination wireless receiver performs uplink (UL) transmission to the AP in one or more PSMP uplink transmission times (UTTs) in a PSMP sequence.

29. The system of claim 28, wherein:
the channel access module utilizes a STA_INFO field in the PSMP frame, wherein the STA_INFO field includes individual wireless receiver addresses, and the STA_INFO Type is set to indicate a MU-MIMO PSMP transmission;
in a PSMP Mixed Mode, the channel access module schedules MU-MIMO DTTs and single user DTTs in the same PSMP sequence, using different STA_INFO fields in the PSMP frame;
wherein MU-MIMO DTT comprises a DTT during which the PPDUs are transmitted using the MU-MIMO.

30. The system of claim 29, wherein:
the channel access module schedules the same PSMP-DTT Start Offset and PSMP-DTT Duration for a MU-MIMO DTT in a PSMP frame; and
each wireless receiver has its own PSMP-UTT Start Offset and PSMP-UTT Duration scheduled in a PSMP frame.

31. The system of claim 28, wherein:
in a PSMP Green Mode, the channel access module schedules a MU-MIMO DTT to be transmitted in a PSMP sequence;

32. The system of claim 31, wherein:
the PSMP frame includes a STA_INFO field, wherein in the STA_INFO field, a STA_INFO Type is set to 3 to indicate a MU-MIMO PSMP transmission, and wherein a frame is always transmitted immediately after the PSMP frame, when no Group Addressed DTTs present.

33. The system of claim 31, wherein:
the channel access module allocates a group addressed DTT immediately after a PSMP frame, followed by MU-MIMO DTTs, followed by single-user DTTs, when no Group Addressed DTTs are present.

34. The system of claim 32, wherein there are two to four wireless receivers.

35. The system of claim 32, wherein there are at least five wireless receivers, such that:
for a wireless receiver to be included in a first MU-MIMO DTT, the STA_INFO Type is to 3, without DTT start offset and DTT duration fields; and
for a wireless receiver to be included in a second MU-MIMO DTT and beyond, the STA_INFO Type is set to 2, such that the wireless station can set appropriate values for their DTT start offset and DTT duration fields.

36. The system of claim 28, wherein:
a wireless receiver need not go to sleep before its own DTT, and may transmit immediately after receiving a PSMP frame, thereby reducing number of On/Off (Wakeup/Sleep) transitions, and neither PSMP-DTT Start Time nor PSMP-DTT Duration are used; and
the wireless communication system comprises a wireless local area network.
